(19) United States
(12) Patent Application Publication
(10) Pub. No.: US 2007/0174173 A1
(43) Pub. Date: Jul. 26, 2007

(54) Method for displaying market data and entering trading orders

(76) Inventor: Steven J. Brucato, Naperville, IL (US)

Correspondence Address: MICHAEL P. MAZZA, LLC, 686 CRESCENT BLVD., GLEN ELYN, IL, 60137, US

(21) Appl. No.: 11/336,154

(22) Filed: Jan. 21, 2006

(51) Int. Cl. G06Q 40/00

(52) U.S. Cl. 705/37; 705/36 R

(57) ABSTRACT

A GUI display and method for mapping market prices and volumes for facilitating electronic trading of a traded instrument. A plurality of prices in the market are displayed for the traded instrument, together with a plurality of corresponding market volumes. Each of the market values may be positioned on the display in a two-dimensional “map” or range of ascending or descending order based on quantity, enabling a trader to quickly assess price levels and relative sizes of corresponding volumes which are active in the market. Working limit orders and working stop orders corresponding to the prices may also be displayed. Aggregate order quantities and/or orders in queue may be displayed. The volume range of the market volumes may be adjusted.

The disclosures of concurrently-filed U.S. Ser. No. ______, titled “A Graphical User Interface And Method For Displaying Market Data And Entering Trading Orders,” concurrently-filed U.S. Ser. No. ______, titled “A Method For Indicating Current Market Prices Across A Range Of Prices,” concurrently-filed U.S. Ser. No. ______, titled “A Method For Estimating The Time Position Of Queued Electronic Orders,” U.S. Ser. No. ______, filed Dec. 21, 2005, titled “A Graphical User Interface And Method For Displaying Market Data And Entering Trading Orders,” U.S. Ser. No. ______, filed Dec. 6, 2005, titled “Method And System for Detecting And Managing Message Throttle Conditions,” and U.S. Pat. Nos. 6,938,011 and 6,772,132, are hereby incorporated by reference into this application in their entirety.

### BACKGROUND OF THE INVENTION

The present invention generally relates to computerized trading systems. More specifically, the invention relates to a novel method for displaying market data and facilitating the entry of trading orders using specialized graphical user interfaces (GUIs).

As trading of stocks, bonds, and derivatives (futures and options) moves ever more into the electronic trading realm, the display of data and the ability to mentally process this data to make an order-entry decision can be important to a trader's success. Also, the ability to quickly enter an order of the correct price and quantity is likewise important to a trader's success.

Accordingly, it would be advantageous to visually present market data so that a trader has an immediate grasp of prices in the market and volumes available at various price levels. It would also be advantageous to allow the trader to more quickly enter trading orders.

### SUMMARY OF THE INVENTION

The present invention enables the presentation of market data in a visual manner that provides a trader with an immediate sense of “where the market is” by presenting the data in a spatial, two-dimensional map. With a quick glance, the trader can rapidly assess both the prices in the market and the volumes available at each price level. By displaying this data spatially in a two-dimensional map, the trader can quickly assess market conditions.

Further, the invention allows for a very quick selection of order entry by pre-populating this same map or grid with various prices and order quantities, so that with a single click, for example, the trader can select both the desired price and order quantity. This is an improvement over other order-entry systems in that the time to enter the order may be reduced from multiple mouse clicks, for example, to a single click.

Accordingly, in a preferred embodiment of the present invention, a GUI display is provided, mapping market prices and volumes for facilitating electronic trading of a traded instrument. The display includes a plurality of prices in the market for the traded instrument, and a plurality of corresponding market volumes. Each of the market values may be positioned on the display in a range of ascending or descending order based on quantity. This enables a user/trader to quickly assess price levels and relative sizes of corresponding volumes which are active in the market.

In alternative or additional embodiment, a plurality of working limit and/or stop orders may be shown on the display, corresponding to the prices. Displayed market volumes may represent an aggregate of working orders in the market for the traded instrument. Displayed volume ranges of the market volumes may be adjusted, such as by using a slider control, including but not limited to showing a single market volume quantity representing all volume for a particular price. In a preferred embodiment, two or more market volumes corresponding to bids and offers may be separately color-coded. Market volumes as to which the trader has an order may be designated, such as by cross-hatching and/or color-coding such as color highlighting. Order quantities may also be displayed, such as orders in queue and/or aggregate order quantities.

In an alternative preferred embodiment, a method is provided for facilitating electronic trading by mapping market prices and volumes for a traded instrument. In this embodiment, a GUI display may be provided of a plurality of prices and a plurality of corresponding market volumes for the traded instrument. Each of the market volumes may be positioned on the display in a range of ascending or descending order based on quantity, and an order at a particular price may be selected. Order selection may be accomplished via a single click of an input device after first positioning a cursor controlled by the input device adjacent a displayed market volume. The display may be divided into bids and offer zones; input device clicks occurring when the cursor is positioned in the bid zone may be interpreted as bids, and clicks occurring when the cursor is positioned in the offer zone may be interpreted as offers.

### BRIEF DESCRIPTION OF THE DRAWINGS

The novel features which are characteristic of the invention are set forth in the appended claims. The invention itself, however, together with further objects and attendant advantages thereof, can be better understood by reference to the following description taken in connection with the accompanying drawings, in which:

FIG. 1 shows a basic graphical user interface (GUI) that displays market data (prices and volumes) in a two-dimensional map (grid) known as Market Map™ while, in a particularly preferred embodiment, simultaneously allowing for market order entry with a single click of a user input device such as a mouse; and

FIGS. 2-5 show alternative GUI Market Map™ embodiments, as described below.

The components in the drawings are not necessarily to scale, emphasis instead being placed upon clearly illustrating the principles of the present invention. In the drawings, like reference numerals designate corresponding parts throughout the several views.

### DEFINITION OF CLAIM TERMS

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Color” means black, grey, white or other colors.

“Click” means a depression or movement of a button or similar device on a mouse or other input device.

“Working limit orders” mean orders that are resting in the market, for a particular quantity and a particular limit price, but have not traded yet.

“Working stop orders” mean orders that will “trigger” and become working limit or market orders once the current traded price in the market meets the conditions of the stop price.

“Working orders” mean any orders resting in the market that have not traded yet, or any orders that will be triggered to enter the market when specific market conditions are met.

“Traded instrument” means any article of commerce which may be traded, including but not limited to stocks, bonds, commodities and derivatives (futures and options).

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

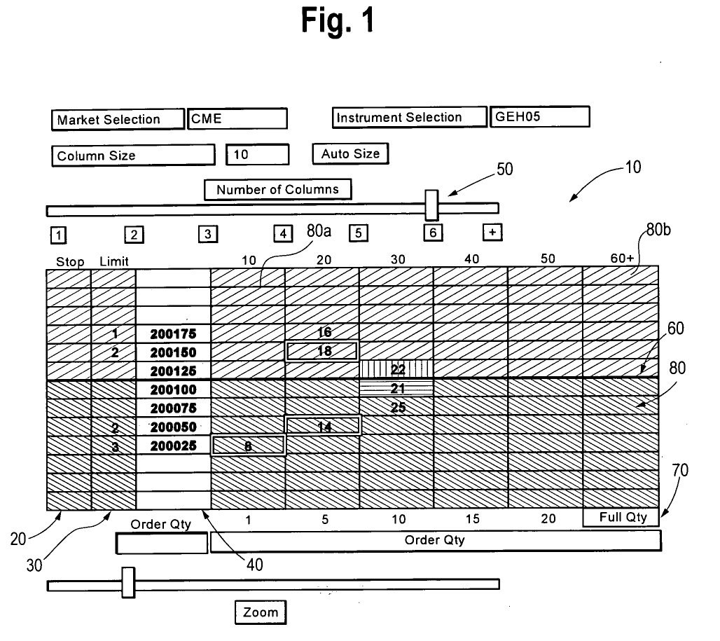

Referring now to FIG. 1, a particularly preferred embodiment of the present invention is shown there, constituting a two-dimensional GUI map or grid 10, known as “Market Map™” and permitting and facilitating trading operations. Columns 20 and 30, respectively, are stop working order and limit working order columns showing the number of working limit orders and working stop orders, entered by the trader. The limit price or stop price of the order is represented by price column 40, which represents the normal range of prices in the market. The number of displayed prices may be adjusted by simply stretching the size of the display window using normal windows-style controls. In this way, the Market Map™ can be made to show all price levels available for order entry.

The columns to the right of the price column represent market volumes. In this embodiment, these represent the aggregate of working orders in the market at the moment. These volumes may be updated in real-time as a price feed is transmitted from the electronic market. In the example of the preferred embodiment shown in FIG. 1, the first column (with label “10”) represents a volume in the range from 1-10, while the “20” column represents any volume in the range of 11-20 (and so on). The volume range of each column may be adjusted using slider control 50. As slider control 50 is moved to the left, the volume range of each column is decreased, for example; at its left-most position, each column will represent a volume size of 1. At the right-most extreme, the slider control will represent a single column showing all volume in one column. Within each volume column, the total working volume at that price level may be displayed. Offers may be shown with a red background, and bids shown with a green background, for example. In the preferred example, a thick line 60 may be used to separate the two and show the boundary between bids and offers. An individual cell may be highlighted in yellow, for example, as shown to indicate that the trader has an order working at that price level within the displayed volume.

Still referring to FIG. 1, bottom row 70 of numbers, below the volume grid, shows the order quantity that will be entered if the trader clicks in that column. The order quantity for each column may be entered by the trader via keyboard; in this manner, the number of order quantities typically used by the trader may be pre-set by the trader.

The Market Map™ embodiment shown in FIG. 1 may be used by the trader as follows. First, the trader can view the current market conditions and ascertain which price levels are active in the market and which volumes are active in the market. As prices levels changes, the individual grid cells (e.g., 80) move up or down. As new prices are added, new cells may appear with the appropriate color and volume. Thus, vertical motion of cells may indicate a change in market prices; in other words, vertical movement of highlights cells may show a price movement in the market either upwardly or downwardly. This display provides the trader with an immediate sense of the overall market “depth,” i.e., how many price levels have volume associated with them.

Using the Market Map™, the trader can assess the volume available at each price level. The further the highlighted cell is located to the right, for example, the greater the volume at that price level. This is believed to represent a significant advantage from previous displays that simply show the volume at each level without providing a spatial sense of the volume that can be assessed quickly, visually and without having to interpret individual digits. It will be appreciated that as highlighted cells move left or right (in the Market Map embodiment shown in FIG. 1), the trader can quickly ascertain changes in market volume within specific price levels.

As it should now be appreciated, the trader can quickly enter orders for any price level by clicking within any individual cell. For example, by clicking in the top left cell 80a, the trader will enter an order at a price of 200250 and a quantity of 1. By clicking in the top right cell 80b, the trader will enter an order at a price of 200250 and quantity of 40. Thus, each cell represents a unique price/quantity combination for order entry. This represents a significant enhancement over existing order-entry systems in that a full range of price/quantity order parameters can be entered with a single click. This represents a savings of one to several clicks which is a significant advantage in fast electronic markets. Clicks entered within the offer zone may be interpreted as offers, while clicks in the bid zone may be interpreted as bids. Additional controls may be provided to allow the trader to override this default behavior, for example (e.g. a “Swipe” button may be used to reverse this convention).

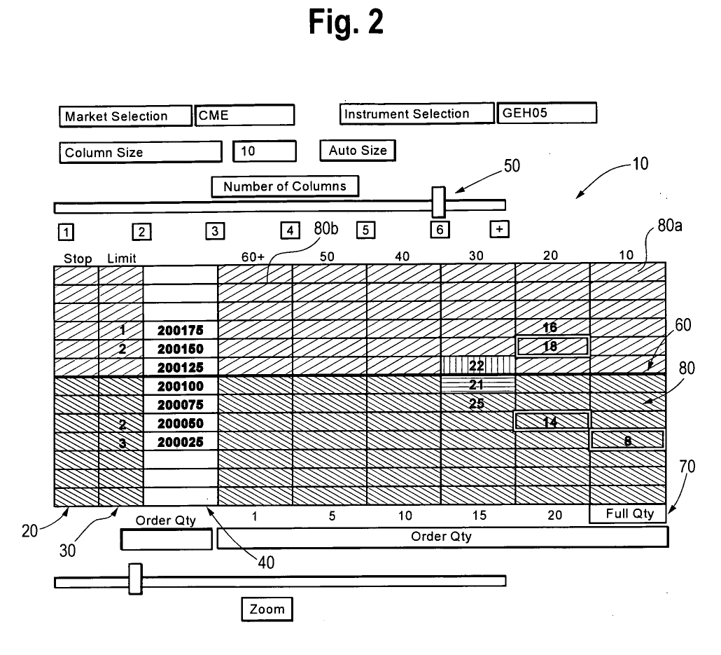

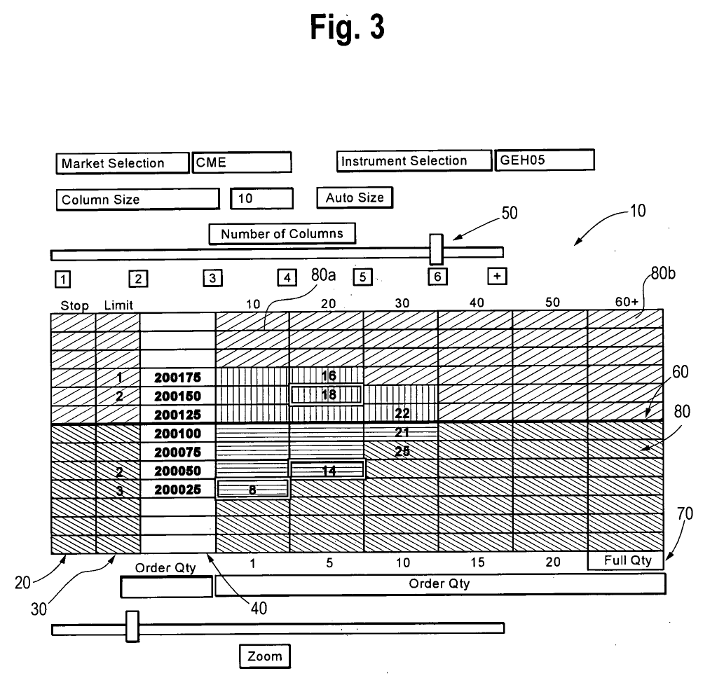

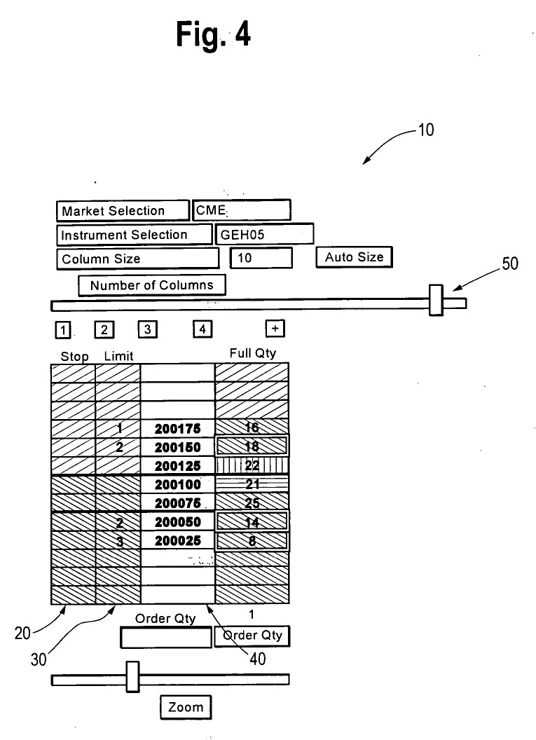

Referring now to FIG. 2, an embodiment of Market Map™ is shown in which the quantity columns are arranged from highest to lowest, left to right. In another alternative embodiment, shown in FIG. 3, histogram quantities are incorporated into the display. Finally, in yet another alternative embodiment, FIG. 4 shows Market Map™ with a single quantity column.

Order Queue Mode

Instead of giving the trader a spatial sense of volume, Market Map™ may also be used to provide the trader with valuable information in terms of the time-order of resting orders in the market. The aggregate volume at any price level is typically composed of many orders from many traders. For example, a bid quantity of 100 at a price of 200250 may be made up of 5 orders each of quantity of 20, or a single order of quantity 100, or of 100 orders of quantity 1. These orders are entered at different times, typically. So if an aggregate bid quantity of 100 is composed of 3 orders, then one of those orders is first in queue (it was the first submitted to the market), the second order submitted is second in queue, and the third order is third in queue. Most electronic markets use some form of time-priority in matching buyers with sellers. This means that if a seller wishes to sell to a buyer, the first buyer in queue (with respect to time) will make the trade. For example, consider three bid orders comprising an aggregate of 100 quantity: assume the first order in the bid queue is for a quantity of 20, the second in queue is for a quantity of 10, and the third is for a quantity of 70 (all at the same price of 200250). A seller wishes to sell 25 at the same price of 200250. When the offer for 25 at 200250 is entered into the market, the first bid order in queue will trade for a quantity of 20 and the second bid order in queue will partially trade for a quantity of 5 (leaving a resting quantity of 5). This will leave 2 bid orders in queue—the first with a quantity of 5 and second with a quantity of 70. This type of matching of buyers and sellers is called price-time priority.

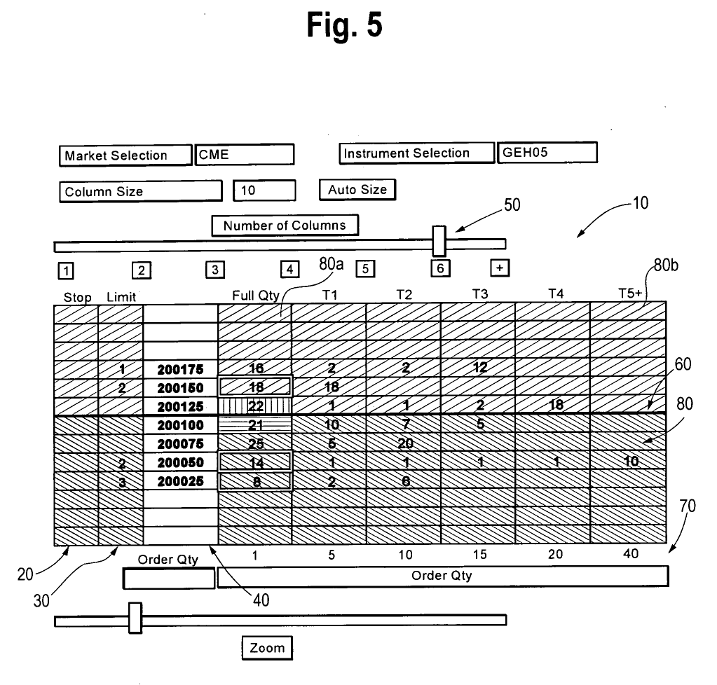

Some electronic markets disseminate market data in such a way that it is possible to either know or approximate the location or orders in queue, as disclosed in co-pending, concurrently-filed U.S. Ser. No. ______, titled “A Method For Estimating The Time Position Of Queued Electronic Orders.” For such markets, the orders in the time queue can be displayed in the Market Map™ as shown in FIG. 5. Here, orders are shown in queue as well as in aggregate order quantity. T1 represents the order first in queue, or the first order that will trade on a time basis. T2 represents the next order in queue in time (behind the T1 order) and so on for T3 and T4. The T5+ column represents the aggregate quantity of all orders in the 5^{th} and greater positions in queue.

Still referring to FIG. 5, the number of columns, each representing a time queue position, may be varied by the user. This information may be very valuable to the trader, to provide a sense of whether there are single large quantity orders in the market, or many smaller quantities. This information, in turn, may affect the trading strategy of a trader to a great degree.

It will now be appreciated by those of ordinary skill in the art that the present invention provides the electronic trader with several advantages which are believed to be significant. These include a faster assessment of both market prices and volumes than conventional, known trading systems by presenting the information in an intuitive, two-dimensional GUI map. In addition, the present invention is believed to provide a faster selection and entry of multiple price/quantities than such systems. Finally, the invention provides the ability to assess the order quantities, for a given price level, in order of their time queue position.

Those of ordinary skill in the art will appreciate that alternative embodiments are possible, while still in keeping with the principles of the present invention. For example, the slider control may be rendered in a vertical direction. The behavior of the price entries may include all the modes of Rotator™ disclosed in U.S. Ser. No. ______ (dynamic, static, scrolling, locked . . . ). The direction of the columns may be changed, as well (i.e., largest to smallest, from left to right or right to left), as shown by example in FIG. 2. In addition, quantities may be shown in histogram form, as shown in FIG. 3. As also explained above, orders-in-queue may be displayed instead of, or in addition to, aggregate quantities.

It is noted that the “Zoom” button at the bottom of each drawing may be used to enlarge or shrink the contents of the (e.g.) CRT monitor window display.

The above description is not intended to limit the meaning of the words used in the following claims that define the invention. Other systems, methods, features, and advantages of the present invention will be, or will become, apparent to one having ordinary skill in the art upon examination of the foregoing drawings, written description and claims, and persons of ordinary skill in the art will understand that a variety of other designs still falling within the scope of the following claims may be envisioned and used. It is contemplated that these or other future modifications in structure, function or result will exist that are not substantial changes and that all such insubstantial changes in what is claimed are intended to be covered by the claims.

I claim:

1. A GUI display mapping market prices and volumes for facilitating electronic trading of a traded instrument, comprising:
a plurality of prices in the market for the traded instrument; and
a plurality of corresponding market volumes wherein each of the market values is positioned on the display in a range of ascending or descending order based on quantity, thereby enabling a trader to quickly assess price levels and relative sizes of corresponding volumes which are active in the market.

2. The GUI display of claim 1, further comprising a plurality of working limit orders corresponding to the prices.

3. The GUI display of claim 1, further comprising a plurality of working stop orders corresponding to the prices.

4. The GUI display of claim 1, wherein the market volumes represent an aggregate of working orders in the market for the traded instrument.

5. The GUI display of claim 1, wherein the volume range of the market volumes may be adjusted.

6. The GUI display of claim 5, wherein adjustment of the market volumes is accomplished using a slider control.

7. The GUI display of claim 5, wherein the volume range may be adjusted to show a single market volume quantity representing all volume for a particular price.

8. The GUI display of claim 1, wherein at least two market volumes corresponding to bids and offers are separately color-coded.

9. The GUI display of claim 1, wherein market volumes as to which the trader has an order are designated.

10. The GUI display of claim 9, wherein the designation comprises color highlighting.

11. The GUI display of claim 1, further comprising a plurality of order quantities.

12. The GUI display of claim 1, wherein the display shows orders in queue as well as aggregate order quantities.

12. A method for facilitating electronic trading by mapping market prices and volumes for a traded instrument, comprising the steps of:
providing a GUI display of a plurality of prices and a plurality of corresponding market volumes for the traded instrument, wherein each of the market volumes is positioned on the display in a range of ascending or descending order based on quantity; and
selecting an order at a particular price.

13. The method of claim 12, wherein order selection is accomplished via a single click of an input device after first positioning a cursor controlled by the input device adjacent a displayed market volume.

14. The method of claim 13, wherein the display is divided into bids and offer zones, and wherein clicks occurring when the cursor is positioned in the bid zone are interpreted as bids and clicks occurring when the cursor is positioned in the offer zone are interpreted as offers.
